(19) United States
(12) Patent Application Publication
(10) Pub. No.: US 2010/0251599 A1
(43) Pub. Date: Oct. 7, 2010

(54) BAITING SYSTEM FOR CRUSTACEANS

(76) Inventor: Aaron Cummins, Anacortes, WA (US)

Correspondence Address: HUGHES LAW FIRM, PLLC, 5160 Industrial Place,#107, Ferndale, WA, 98248-7819, US

(21) Appl. No.: 12/576,109

(22) Filed: Oct. 8, 2009

Related U.S. Application Data
(60) Provisional application No. 61/103,694, filed on Oct. 8, 2008.

(51) Int. Cl. A01K 69/06; A01K 97/04

(52) U.S. Cl. 43/100; 43/44.99

(57) ABSTRACT

A system for supplying crab bait or bait for crustaceans by providing a porous structure, having an inner chamber for placing bait therein, where a connection portion can be connected to a crustacean trap device.

### RELATED APPLICATIONS

This application claims priority benefits of U.S. Ser. No. 61/103,694, filed Oct. 8, 2008.

### BACKGROUND OF THE DISCLOSURE

The endeavor of catching crustaceans referred to as “crabbing” has a long tradition in ocean seaside culture. Families, individual and various crabbing enthusiasts seek to catch crustaceans, mainly crabs, by a conventional method of utilizing some form of a crab pot. Crabbing is an endeavor that is generally seasonal, as crabbing enthusiasts prepare themselves for a crabbing season to enjoy feasting upon fresh crab caught in ocean waters. The process of crabbing itself is generally an enjoyed ritual by these enthusiasts, including the retrieval of the crab pot, preparation of some form of a boat or floating apparatus or simply access to ocean waters of sufficient depth to dispense the pot, and further handling of the crab bait, which is a necessary element of crabbing.

Crab bait can historically be comprised of a variety of organic products, and in particular meat-orientated waste products, such as waste products from the filleting of salmon or other fish, or even from other sources altogether outside of seafood. In general, the handling of crab bait is not the most pleasant element of the fine endeavor of crabbing. Oftentimes the waste products from fish have been discarded and are possibly aged to some degree causing a certain amount of smell and a slimy texture during handling. Further, crab bait must generally be hooked or otherwise attached to the interior chamber portion of a crab pot so as to lure the crabs therein. Dealing with sharp hooks while maneuvering on a dinghy or other unstable craft is not particularly safe, and further, having to handle raw crab bait with bare hands tends to transmit a fish smell on the individual's hands, which in turn is transmitted therefrom to, for example, a boat steering wheel or the individual's clothes, and generally surrounds the individual with the overall smell of fish, more particularly the rather pungent smell of aged fish waste portions.

Various attempts in the prior art have been utilized to contain bait, and various wire mesh type elements or nylon type pouches that are of an enduring nature can house bait therein. However, these containers themselves are designed to be reused and require handling after use.

Therefore, a persistent problem exists where individuals who enjoy the sport and endeavor of crabbing must endure the unpleasantness of dealing with the bait or the bait containers, which has various negative ramifications including proliferating the smell of the bait, general dangers with dealing with the bait including the sharp bones, the potential of litter and frustrated users throwing away containers which are not sufficiently biodegradable, and other complications and unpleasant aspects of the handling.

Therefore is a need for providing a system for a contained bait holder with an interior chamber made from a pliable material having porosity sufficient to allow portions of the bait to travel therethrough while still being contained within the central chamber region provides a workable solution to an age-old problem of crab-bait handling. Further, the system provides an underlying material that is sufficiently biodegradable so as to be disposable and supports the ecosystem of an ocean culture without providing any material to be deposited therein which is an eyesore or otherwise harmful to the environment.

### BRIEF DESCRIPTION OF THE DRAWINGS

FIG. 1 shows an isometric view of a crabbing system comprising one form of a crab pot and a bait system;

FIG. 2 shows a view of an example page system comprising a porous structure which forms a bait containment region and an attachment region;

FIG. 3 shows another isometric view of the crabbing assembly.

### DETAILED DESCRIPTION

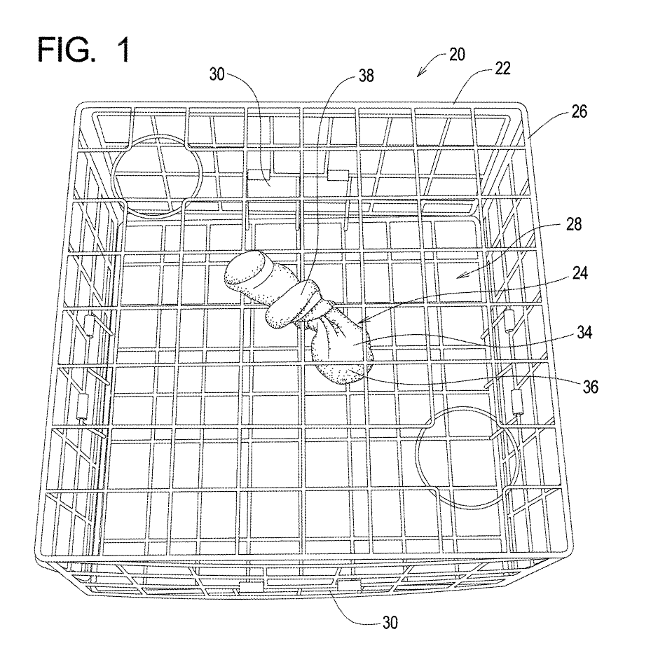

As shown in FIG. 1 there is a crabbing assembly 20. In general, the crabbing assembly 20 comprises a crab pot 22 and a bait system 24. The crab pot 22 is a conventional design, and one type of crab pot is shown in FIG. 1 with the understanding that any type of crab pot can be employed. In general, the crab pot 22 comprises a rigid frame 26 generally comprising an interior chamber region 28. An entry port 30 is provided which generally provides a one-way type entrance so the crabs enter and cannot exit. Of course, in other forms, the raising of the crab pot seals the interior chamber 28 to catch the crab therein.

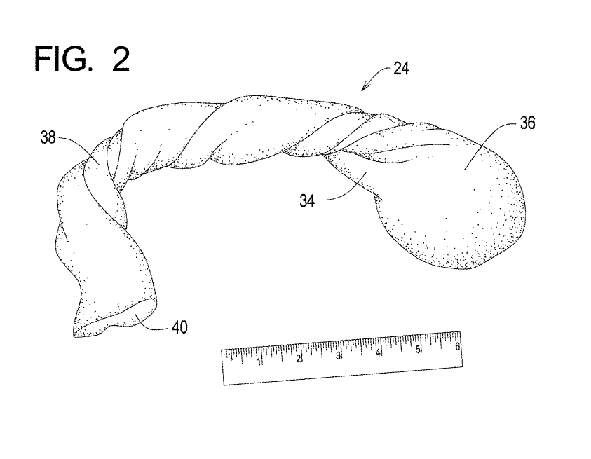

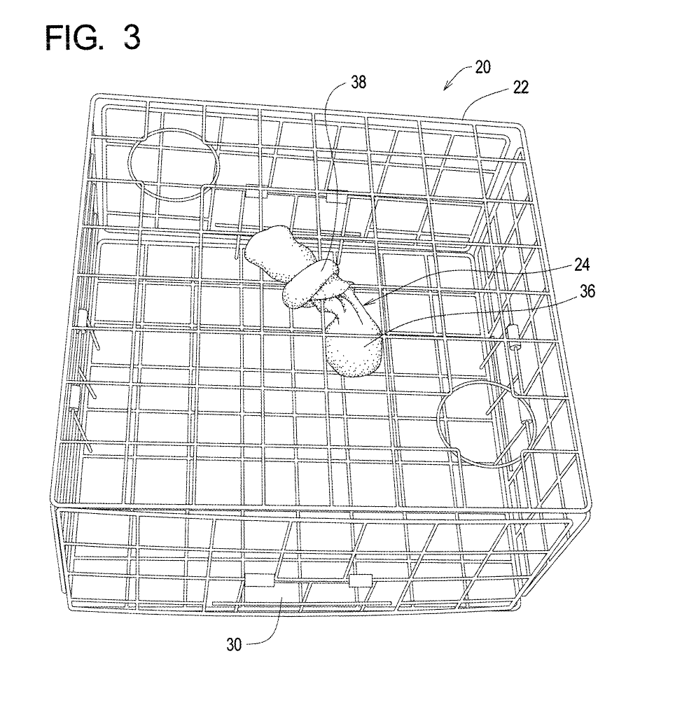

As shown in FIG. 1 there is a bait system 24. The bait system 24 comprises a porous structure 34 generally having a bait containment region 36 and an attachment region 38. The porous structure 34 as shown in FIG. 2 can be comprised of a cotton-type weave, and in one form located near the attachment region 38 is an opening 40 providing access to a central chamber region contained therein. The central chamber region extends to the bait containment region 36 where bait is collected in the central chamber and the porous nature of the porous structure 34 allows for various portions of the bait to be passed through the plurality of porous holes to provide a scent for the crabs. In general, when the crabs (or crustaceans in general) grasp the bait containment region with their claws, this action modifies the interior 40 of the bait containment region and the internal bait is squished and otherwise agitated so as to release more of the bait scent through the pores to attract additional crabs. This action generally creates a type of feeding frenzy with the crustaceans having the phenomena of attracting a large amount of crustaceans therein to the central chamber of the crab pot 22 as shown in FIG. 3. In one form, the bait system 24 can be comprised in a manner similar to a conventional cotton sock. Cotton is a desirable material because it is biodegradable.

The cotton fibers can be treated with solutions of nitric acid of different concentration to assist degradation in the internal kinetic region. Further flax fibers can be utilized to form the porous structure 34. Additional treatments include treatment to the fibers by using various techniques, including chemical and thermal degradation, radiation degradation and combinations thereof. Further, the porous structure 34 can be comprised of synthetic polymers, and in one form, polymers based on cereal grain, flowers or starch as described in U.S. Pat. No. 7,148,272 which is incorporated by reference. In general, accelerating the biodegradable timeframe for the porous structure 34 is desirable, whereas the life of the bait system 24 is in general limited to, for example, no more than 24 hours, and certain regulations demand retrieval of crab pots within a prescribed time.

Therefore, it is desirable to have a biodegradable rate that is sufficient so as the bait system 24 sufficiently degrades, it can be disposed of without penalty of law or suffering to one's personal conscience of disposing the porous structure 34 with any remaining bait into the ocean. Therefore, the porous structure 34, as shown in FIG. 2, will generally undergo an accelerated breakdown process so to generally weaken the fibers to provide accelerated biodegradation when they are placed into the ocean. In general, ocean waters can range in temperature. It is common to have waters in the Pacific Northwest at around 60° F. which is a cooler temperature than in the Atlantic, for example. The biodegradation of the porous structure 34 in such that it can be executed in colder waters. One such material that can be utilized is material related to stitching for patterns wherein this particular material will lose its structural integrity when deposited in warm water for a period of time. Another type of material that can be utilized is fibers comprised of a cellulose base. A cellulose-based system is hydrophilic (attracted to water) and is biodegradable. These various fibers can be treated in acidic environments or be treated with materials to make the fibers more conducive for breakdown by bacteria, in particular seaborne bacteria and plankton.

It should further be noted that the bait system 24 need not necessarily be biodegradable, but may be properly disposable in the ocean. For example, the bait system may be made of a structure held together by an adhesive which breaks down in water over a period of time, in for example 6—48 hours. The breakdown may disassemble the fibers, which for example could be cotton, cellulose or a type of polymer fiber which disassembles and can be properly disposed of within the ocean. The disassembly may, for example, increase the surface area of the fibers, facilitating a later biodegradable breakdown. Further, the disassembly of the fibers may inhibit marring of the landscape, whereas for example the assembled version of the bait system 24 could possibly be considered an eyesore if it were to wash upon the shore. After the disassembly, in time the material can degrade, say for example over an extended period of weeks and months.

It should further be noted that various alternatives to the bait system 24 can be provided. For example, longitudinally extending structural members can extend therealong and be connected to structural members of a lower tensile strength. For example, the porous structure 34 could have longitudinally extending cotton fibers with for example paper-like cellulosic fibers interwoven therewith. The cotton fibers may withstand the rigor of crustaceans applying force thereupon with their claws, but after a general range of interaction with a crab, the weaker fibers will generally break down and hence the crabs would have facilitated in the breakdown of the porous structure 34. The stronger elongated fibers could be comprised of materials such as hides, paper, wood, beeswax derivative products, cotton, excelsior (wood wool), fique, flax, jute, straw, stover to list a few possible materials.

In one form, the porous structure 34 can be constructed by having longitudinal extending flexible structural members, as described above where the stronger members are somewhat camouflaged so as not to be an eyesore when separated from the interwoven less structural strength members. Therefore, when the crabs tear at the porous structure 34, they facilitate the disintegration, and the elongate members could be made from a material which is biodegradable, but the structures could for example resemble an item such as seaweed or another natural type elongate structure so as not to be an eyesore. The material can have a net density greater than that of water so it does not float and become a navigational hazard to boaters or an eyesore on the surface of the water. In this manner, the unit still operates as being biodegradable, but during the degrading process it is not readialy noticeable to cause any social problems with crabbers disposing of their bait containers. In other words, the material can partially disintegrate to resemble a natural material found in the ocean waters, or for that matter a portion of the porous structure 34 could be constructed out of such materials such as seaweed or kelp.

With regard to the method of distribution of the bait system 24, in general the bait system 24 could be sold within a retail outlet, such as a fishing supply store. The interior chamber of the bait system, and in particular the interior chamber of the bait containment region 36, can house bait therein. Therefore, the user need not handle the crab bait correctly as there is an interposed wall therebetween. The bait system 24 could, for example, be frozen or contained together with other bait systems in a non-porous bag for storage. The bait containment region 36 can be filled at, for example a manufacturing location having waste product which would suffice as crab bait. For example, various porous structures 34 could be supplied to a fish processing plant where the waste product from the fish processing plant can be utilized to directly be placed within the opening 40 of the porous structure 34 for a prescribed amount of bait to be contained at the bait containment region 36. Thereafter the bait systems 24 can be sold to end users or through value-added retailers, such as bait stores, for a better utilization of waste products.

Prior to placing bait therein, the porous structure 34 could undergo the above-mentioned treatment to facilitate breakdown thereof when in operation. In one form of utilizing the bait system, the bait to be deposited can be for example initially frozen and deposited in the central chamber of the bait containment region. Thereafter, the entire bait system is placed in an environment below freezing to maintain the bait at a frozen solid state. Thereafter when the bait thaws, the breakdown process of the porous structure 34 begins. In this way, the frozen internal bait will remain at bay from breaking down or otherwise biodegrading the porous structure 34, particularly at the bait containment region 36 until it thaws.

In other forms, an interior membrane contained within the chamber region, in particular the bait containment region 36, can hold bait therein, this membrane being “cracked” or otherwise of compromised integrity so as to release the bait therefrom. This allows the porous structure 34 to avoiding leaking the containment of the pungent bait until necessary.

As shown in FIGS. 1 and 3, the attached region 38 can be an elongated portion of sufficient length to be tied to the upper portion of the crab pot 22. A simple knot will generally suffice for securing the bait, and of course other attachment systems could be utilized, such as clamps, fasteners, adhesives, or other elements that can be properly disposed of along with the entire bait system 24 in the ocean.

Therefore, it can be appreciated that the crabbing assembly 20 shown in FIGS. 1 and 3 provides the components of the bait system 24 as shown in FIG. 2, which can be properly disposed of correctly in the ocean immediately after use and limits the amount of physical contact necessary with the underlying crab bait to catch crabs or crustaceans in general.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A bait system comprising a porous structure having a bait containment region and an attachment region an opening is providing access to a central chamber region contained therein.
